(19) United States
(12) Patent Application Publication
(10) Pub. No.: US 2026/0251189 A1
(43) Pub. Date: Aug. 27, 2026

(54) BRAKE CALIPER ANCHOR BRACKET

(71) Applicant: ZF Active Safety US Inc., Livonia, MI (US)

(72) Inventors: Jonathan Wemple, Livonia, MI (US); Sean Barrett, Livonia, MI (US); Peter Kula, Livonia, MI (US)

(21) Appl. No.: 19/060,104

(22) Filed: Feb. 21, 2025

(51) Int. Cl. F16D 55/22; F16D 55/00

(52) U.S. Cl. CPC F16D 55/22; F16D 2055/0008

(57) ABSTRACT

An anchor bracket configured to connect a brake caliper of a brake assembly to a vehicle includes at least one fastener opening extending through an inboard surface of the anchor bracket. The at least one fastener opening is configured to receive a fastener to connect the anchor bracket to a stationary vehicle part. The inboard surface of the anchor bracket is configured to engage the stationary vehicle part. At least one projection extends axially from the inboard surface of the anchor bracket and is configured to engage the stationary vehicle part.

### TECHNICAL FIELD

The present invention relates to vehicle disc brake assemblies and, in particular, relates to an anchor bracket for connecting a caliper of the disc brake assembly to a vehicle.

### BACKGROUND

A typical disc brake assembly includes a brake disc or rotor secured to a wheel of the vehicle for rotation therewith. The disc brake assembly further includes a caliper that is slidably supported on guide pins secured to an anchor bracket. The anchor bracket is connected to a non-rotatable component of the vehicle, such as an axle flange or a steering knuckle, which is connected to the vehicle frame. The caliper includes a pair of brake pads which are disposed on opposite sides of the brake rotor. The brake pads are connected to one or more hydraulically or pneumatically actuated pistons for movement between a non-braking position and a braking position. In the braking position, the brake pads are moved into frictional engagement with the opposed braking surfaces of the brake rotor. For example, when the operator of the vehicle depresses the brake pedal, the piston urges the brake pads from the non-braking position to the braking position so as to frictionally engage the opposed braking surfaces of the brake rotor and thereby slow or stop rotation of the associated wheel of the vehicle.

The anchor bracket may move relative to the vehicle during operation of the disc brake assembly. The movement of the anchor bracket relative to the vehicle may cause openings in the anchor bracket into which the guide pins extend to deform. The deformation of the guide pin openings may create high loading on the guide pins. It is therefore advantageous to reduce movement of the anchor bracket relative to the vehicle.

### SUMMARY

The present invention relates to an anchor bracket configured to connect a brake caliper of a brake assembly to a vehicle. The anchor bracket includes at least one fastener opening extending through an inboard surface of the anchor bracket. The at least one fastener opening is configured to receive a fastener to connect the anchor bracket to a stationary vehicle part. The inboard surface of the anchor bracket is configured to engage the stationary vehicle part. At least one projection extends axially from the inboard surface of the anchor bracket and is configured to engage the stationary vehicle part.

In accordance with one of the features of the present invention, the at least one projection has a linear shape and extends radially from the fastener opening.

In accordance with another feature of the present invention, the at least one projection has a height extending axially from the inboard surface of between 0.05 mm and 1.5 mm and a width of between 0.5 mm and 1.5 mm.

In accordance with another feature of the present invention, the anchor bracket includes a plurality of projections extending axially from the inboard surface of the anchor bracket.

In accordance with another feature of the present invention, each projection is perpendicular to an adjacent projection.

In accordance with another feature of the present invention, each projection extends at a 30° angle to an adjacent projection.

In accordance with another feature of the present invention, the anchor bracket includes four projections extending radially from the fastener opening.

In accordance with another feature of the present invention, the anchor bracket includes twelve projections extending radially from the fastener opening.

In accordance with another feature of the present invention, the projection is machined into the inboard surface.

In accordance with another feature of the present invention, the projection is formed by laser marking the inboard surface.

In accordance with another feature of the present invention, the anchor bracket includes a plurality of fastener openings extending through a plurality of inboard surfaces. Each of the inboard surfaces has at least one axially extending projection configured to engage the stationary vehicle part.

In accordance with another feature of the present invention, the anchor bracket includes first and second arms extending generally parallel to each other and to an axis of a vehicle wheel when the anchor bracket is connected to the vehicle. The fastener openings are on opposite ends of an inner tie bar that interconnects the first and second arms.

In accordance with another feature of the present invention, the anchor bracket includes first and second guide pin openings that are configured to receive guide pins that support the caliper for sliding movement relative to the anchor bracket.

Other objects and advantages and a fuller understanding of the invention will be had from the following detailed description and the accompanying drawings.

### BRIEF DESCRIPTION OF THE DRAWINGS

FIG. 1 is an perspective view of a first embodiment of an anchor bracket constructed in accordance with the present invention;

FIG. 2 is a plan view of the anchor bracket of FIG. 1; and

FIG. 3 is a plan view of a second embodiment of an anchor bracket constructed in accordance with the present invention.

### DETAILED DESCRIPTION

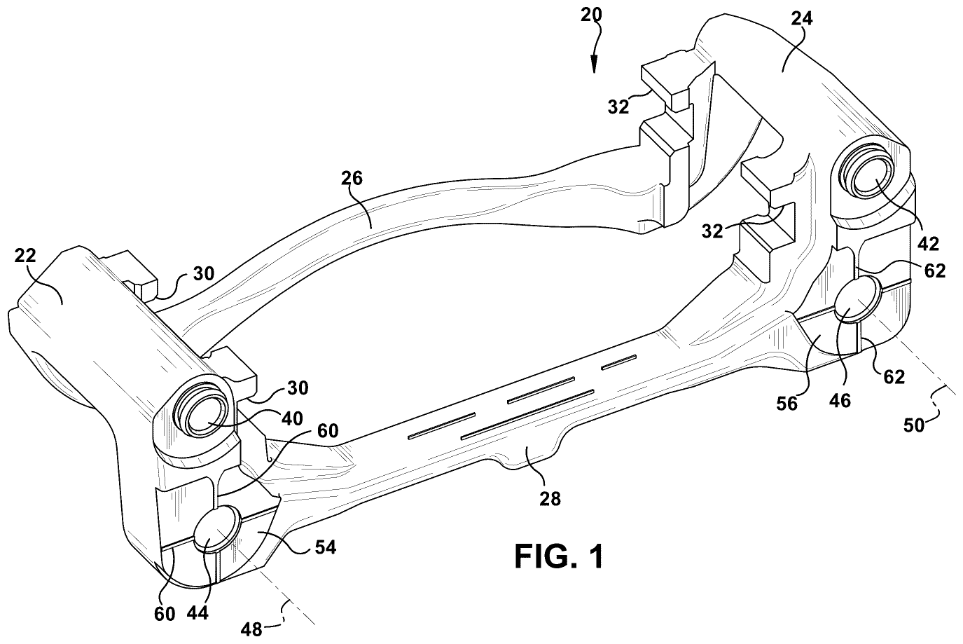

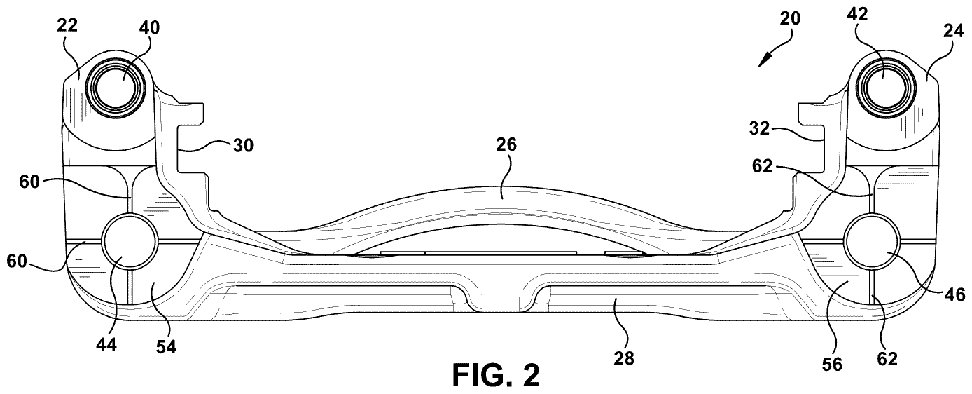

An anchor bracket 20 for a disc brake assembly constructed in accordance with the present invention is illustrated in FIGS. 1 and 2. The anchor bracket 20 includes first and second arms 22, 24 extending parallel to each other. The arms 22, 24 extend generally parallel to an axis of a vehicle wheel when the anchor bracket 20 is connected to the vehicle. The arms 22, 24 are interconnected at their outboard ends by an outer tie bar 26 and interconnected at their inboard ends by an inner tie bar 28. A brake rotor or disc connected to the vehicle wheel extends between the outer and inner tie bars 26, 28 when the anchor bracket 10 is connected to the vehicle. Alternatively, the anchor bracket 20 can be constructed to include only one of the outer tie bar 26 or inner tie bar 28.

The first arm 22 includes first notches or channels 30 on inner walls of the first arm 22. The second arm 24 includes second notches or channels 32 on inner walls of the second arm 24. The first and second channels 30, 32 slidably support inboard and outboard brake pads in a known manner.

The anchor bracket 20 includes first and second spaced apart guide pin openings 40, 42. The guide pin openings 40, 42 extend axially through the arms 22, 24 and may be non-threaded openings. The first and second guide pin openings 40, 42 are each adapted to receive a guide pin that supports a caliper for sliding movement relative to the bracket 20 in a known manner. The caliper may move the brake pads between a non-braking position spaced from the brake rotor and a braking position in frictional engagement with the brake rotor.

The anchor bracket 20 includes first and second spaced apart fastener openings 44, 46. The first and second fastener openings 44, 46 may be located at opposite ends of the inner tie bar 28. The first and second fastener openings 44, 46 have axes 48, 50 extending parallel to each other and to the guide pin openings 40, 42. The first and second fastener openings 44, 46 may be threaded and are each configured to receive a mounting fastener. The mounting fasteners extend into the first and second openings 44, 46 and are received in openings provided in a stationary vehicle component, such as an axle flange or steering knuckle of the vehicle, to connect the anchor bracket 20 to the stationary vehicle component in a known manner. Although the anchor bracket 20 is shown as having two fastener openings 44, 46, it is contemplated that the anchor bracket may have at least one fastener opening and may have any desired number of fastener openings, such as four.

The first and second fastener openings 44, 46 extend through inboard surfaces 54, 56 of the anchor bracket 20. The inboard surfaces 54, 56 are configured to engage the stationary vehicle component when the anchor bracket 20 is connected to the vehicle. The surfaces 54, 56 have at least one projection 60, 62 extending axially toward the vehicle component when the bracket 20 is connected to the vehicle. The projections 60, 62 are configured to engage the vehicle component and may be imbedded into the vehicle component to help prevent movement of the anchor bracket 20 relative to the vehicle component. It is contemplated that any desired inboard surfaces through which fastener openings extend may have projections. Therefore, it is contemplated that the anchor bracket 20 may have four inboard surfaces with projections if the anchor bracket has four fastener openings.

The projections 60, 62 may be generally linear in shape and extend radially from the fastener openings 44, 46. The projections 60, 62 may have any desired cross-sectional shape, such as rectangular, square, or triangular. Each surface 54, 56 may include four projections 60, 62. The projections 60, 62 may extend generally perpendicular to adjacent projections. The projections 60, 62 may have a height extending axially from the surfaces 54, 56 of between 0.05 mm and 1.5 mm and a width of between 0.5 mm and 1.5 mm. Although four projections 60, 62 are shown in FIGS. 1 and 2, it is contemplated that each surface 54, 56 may have any number of projections. It is also contemplated that the surface 54 may have a different number of projections 60 than the number of projections 62 on the surface 56.

The anchor bracket 20 may be formed in any desired manner, such as by casting, and the projections 60, 62 may be formed in the anchor bracket 20 by machining the surfaces 54, 56. Alternatively, the projections 60, 62 may be formed by laser marking after the anchor bracket 20 is formed. The laser marking forms the projections 60, 62 by creating iron oxide peaks that extend from the surfaces 54, 56.

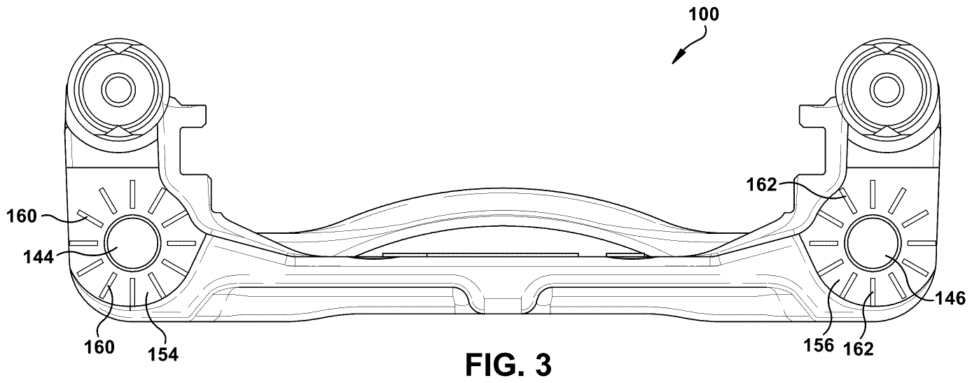

A second embodiment of an anchor bracket 100 made in accordance with the present invention is schematically illustrated in FIG. 3. The second embodiment of the anchor bracket 100 is generally similar to the first embodiment of the anchor bracket 20. The second embodiment of the anchor bracket 100 may have 12 projections 160, 162 formed on the inboard surfaces 154, 156. The projections 160, 162 may extend radially from the fastener openings 144, 146. Each of the projections 160, 162 may extend at a 30° angle to an adjacent projection. Although the projections 160, 162 are described as extending at equal angles relative to each other, it is contemplated that the projections may extend at any desired angles relative to each other.

What have been described above are examples of the present invention. It is, of course, not possible to describe every conceivable combination of components or methodologies for purposes of describing the present invention, but one of ordinary skill in the art will recognize that many further combinations and permutations of the present invention are possible. It is contemplated that the anchor bracket of the present invention may have any desired number of fastener openings. It is also contemplated that each of the inboard surfaces through which the fastener openings extend may have any number of projections. Accordingly, the present invention is intended to embrace all such alterations, modifications and variations that fall within the spirit and scope of the appended claims.

What is claimed is:

1. An anchor bracket configured to connect a brake caliper of a brake
assembly to a vehicle; the anchor bracket comprising:
at least one fastener opening extending through an inboard surface of the anchor bracket, the at least one fastener opening being configured to receive a fastener to connect the anchor bracket to a stationary vehicle part, the inboard surface of the anchor bracket being configured to engage the stationary vehicle part; and
at least one projection extending axially from the inboard surface of the anchor bracket and configured to engage the stationary vehicle part.

2. The anchor bracket as set forth in claim 1, wherein the at least one projection has a linear shape and extends radially from the fastener opening.

3. The anchor bracket as set forth in claim 2, wherein the at least one projection has a height extending axially from the inboard surface of between 0.05 mm and 1.5 mm and a width of between 0.5 mm and 1.5 mm.

4. The anchor bracket as set forth in claim 1, wherein the anchor bracket includes a plurality of projections extending axially from the inboard surface of the anchor bracket.

5. The anchor bracket as set forth in claim 4, wherein each of the plurality of projections has a linear shape and extends radially from the fastener opening.

6. The anchor bracket as set forth in claim 5, wherein each projection is perpendicular to an adjacent projection.

7. The anchor bracket as set forth in claim 5, wherein each projection extends at a 30° angle to an adjacent projection.

8. The anchor bracket as set forth in claim 5, wherein the anchor bracket includes four projections extending radially from the fastener opening.

9. The anchor bracket as set forth in claim 5, wherein the anchor bracket includes twelve projections extending radially from the fastener opening.

10. The anchor bracket as set forth in claim 1, wherein the projection is machined into the inboard surface.

11. The anchor bracket as set forth in claim 1, wherein the projection is formed by laser marking the inboard surface.

12. The anchor bracket as set forth in claim 1, wherein the anchor bracket includes a plurality of fastener openings extending through a plurality of inboard surfaces, each of the inboard surfaces having at least one axially extending projection configured to engage the stationary vehicle part.

13. The anchor bracket as set forth in claim 12, wherein each of the at least one axially extending projections has a linear shape and extends radially from one of the plurality of fastener openings.

14. The anchor bracket as set forth in claim 13, wherein each of the axially extending projections has a height extending axially from the inboard surface of between 0.05 mm and 1.5 mm and a width of between 0.5 mm and 1.5 mm.

15. The anchor bracket as set forth in claim 12, wherein each of the inboard surfaces includes a plurality of axially extending projections.

16. The anchor bracket as set forth in claim 15, wherein each of the plurality of projections has a linear shape and extends radially from one of the plurality of fastener openings.

17. The anchor bracket as set forth in claim 16, wherein four projections extend radially from each of the fastener openings, each projection being perpendicular to an adjacent projection.

18. The anchor bracket as set forth in claim 16, wherein twelve projections extend radially from each of the fastener openings, each projection extending at a 30° angle to an adjacent projection.

19. The anchor bracket as set forth in claim 12 wherein the anchor bracket includes first and second arms extending generally parallel to each other and to an axis of a vehicle wheel when the anchor bracket is connected to the vehicle, the fastener openings being on opposite ends of an inner tie bar that interconnects the first and second arms.

20. The anchor bracket as set forth in claim 19 wherein the anchor bracket includes first and second guide pin openings that are configured to receive guide pins that support the caliper for sliding movement relative to the anchor bracket.
